(19) United States
(12) Patent Application Publication
(10) Pub. No.: US 2017/0120188 A1
(43) Pub. Date: May 4, 2017

(54) PROCESS FOR THE PRODUCTION OF REACTIVE COMPOSITION PARTICLES BASED ON SODIUM CARBONATE AND REACTIVE COMPOSITION PARTICLES

(71) Applicant: SOLVAY SA, Brussels (BE)

(72) Inventor: Marc THIJSSEN, Overijse (BE)

(73) Assignee: SOLVAY SA, Brussels (BE)

(21) Appl. No.: 15/317,649

(22) PCT Filed: Jun. 10, 2015
(86) PCT No.: PCT/EP2015/062894

§ 371 Date: Dec. 9, 2016

(30) Foreign Application Priority Data
Jun. 10, 2014 (EP) PCT/EP2014/062007

(51) Int. Cl. B01D 53/50; B01D 53/68; C01D 7/12

(52) U.S. Cl. CPC B01D 53/508; C01D 7/123; B01D 53/685; B01D 2251/304; B01D 2251/606

(57) ABSTRACT

Process for the production of reactive composition particles comprising at least 60% by weight of sodium carbonate and having a BET specific surface of at least 4 m²/g, according to which particles based on sodium bicarbonate and/or sodium sesquicarbonate having a median particle size D₅₀ of less than 35 μm are brought into contact with a stream of hot gases having a temperature of at least 100° C. in order to convert the sodium bicarbonate into sodium carbonate by calcination, the stream of hot gases comprising calcined particles subsequently being subjected to a separation stage in order to obtain, on the one hand, the reactive composition particles and, on the other hand, a separated stream of hot gases comprising CO₂ and steam, the separated stream of hot gases being at least partly recycled upstream of the separation stage.

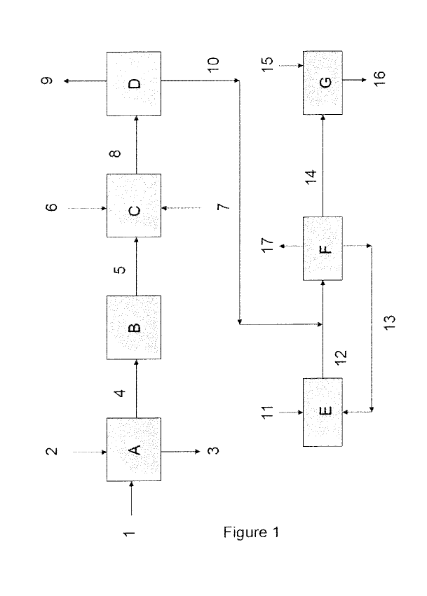

This application claims priority to international application No. PCT/EP2014/062007 filed Jun. 10, 2014, the whole content of this application being incorporated herein by reference for all purposes.

### TECHNICAL FIELD

The invention relates to a process for the production of reactive composition particles based on sodium carbonate and to the reactive composition particles which can be obtained by this process. It also relates to the use of these reactive composition particles based on sodium carbonate as reactant in the treatment of flue gases.

### TECHNICAL BACKGROUND

Sodium carbonate is one of the chemicals having the most numerous applications. In some of these applications, it is advantageous for it to be in the form of particles having a high specific surface. This is because such a sodium carbonate, which also has a high absorptivity with respect to various substances, can constitute an advantageous absorbing vehicle. A high specific surface also confers on it a greater reactivity with gases, which constitutes an advantage.

It is thus in particular an advantage in flue gas purification. It is known that acidic compounds, such as hydrogen chloride and sulphur oxides, can be removed from a flue gas by bringing the latter into contact with sodium bicarbonate particles. In these processes, it is important for the flue gas to have a sufficient temperature in order to thermally decompose the sodium bicarbonate into sodium carbonate. The latter then has a high reactivity with respect to the acidic contaminants. It is also known that sodium bicarbonate particles can be directly replaced with sodium carbonate particles, provided that the latter have a high specific surface. The sodium carbonate particles react with the acidic compounds and are converted into salt particles. The latter, which constitute the purification waste, are then removed from the purified flue gas by filtration. A description is given, in EP 1 051 353 B1, of a process for the purification of a gas from acidic compounds, according to which the gas is subjected to a treatment by a dry or semi-wet route with a basic reactant comprising a sodium carbonate powder with a specific surface of greater than 5 m²/g. This known process is characterized by the handling of the powder in an atmosphere exhibiting a relative humidity of less than 7% and/or by the addition to the powder of desiccating agents, in order for it to retain its high specific surface. In EP 1 051 353 B1, the sodium carbonate is produced by decomposition in a particularly dry atmosphere. Given that the decomposition of sodium bicarbonate produces water, it has appeared difficult to produce sodium carbonate having a high specific surface by such a process in the amounts required to purify flue gases on a large scale, while keeping the production costs competitive with respect to other purification techniques.

A description is given, in EP 0 986 515 B1, of a process for the production of a composition essentially comprising absorbing alkali metal (preferably sodium) carbonate in which ammonium bicarbonate is thermally decomposed. This process is characterized by the specific means employed to entrain the gaseous decomposition products out of the equipment used for the production process. This known process makes it possible to produce sodium carbonate having a specific surface varying between 1.6 and 2.4 m²/g. Such values are insufficient to obtain a treatment of flue gases which is as effective as that obtained by the use of sodium bicarbonate.

EP 0 881 194 A1 discloses a method for preparing sodium carbonate active at temperatures exceeding 400° C., in which sodium bicarbonate is heat-treated at a temperature of between 80 and 250° C. The sodium bicarbonate has a particle size of between 53 and 125 μm and the heat treatment can be conducted in the presence of an activation gas which may consist of an air and/or inert gas, steam and/or carbon dioxide mixture. The reaction of small sodium bicarbonate particles having a median particle size D₅₀ of less than 35 μm in the presence of steam is not disclosed.

Furthermore, Mocek et al. describe in Materials Chemistry and Physics 14 (1986) 219-227 the morphological nature of sodium carbonate produced by thermal decomposition from sodium bicarbonate. The preparation of dense sodium carbonate from sodium bicarbonate is described in U.S. Pat. No. 3,333,918. A method of neutralizing industrial waste gases employing a material obtained by thermal decomposition of sodium bicarbonate having a grain size of 0.33 to 0.50 mm is described in U.S. Pat. No. 4,105,744. A process for making a sorbent comprising mixing at least one alumina compound with a solid metal carbonate is described in US 2010/0222215. A process for producing sodium carbonate from trona is disclosed in U.S. Pat. No. 3,869,538. A method for preparing soda ash from crude trona containing organic impurities by calcining the crude trona is described in U.S. Pat. No. 3,836,628. The production of pure sodium carbonate from Wyoming trona is disclosed in U.S. Pat. No. 2,770,524. Sodium carbonate recovered from the mother liquor bleed is described in U.S. Pat. No. 3,273,959.

The invention is targeted at providing a process for the production of sodium carbonate having a specific surface of at least 4 m²/g which can be use of on a large scale with reduced costs, in order to further open up new applications for sodium carbonate.

### SUMMARY OF THE INVENTION

Consequently, the invention relates to a process for the production of reactive composition particles comprising at least 60% by weight, preferably at least 80% by weight and more preferably at least 90% by weight of sodium carbonate and having a BET specific surface of at least 4 m²/g, preferably of at least 6 m²/g, according to which particles based on sodium bicarbonate and/or sodium sesquicarbonate having a median particle size D₅₀ of less than 35 μm, preferably of less than 25 μm, are brought into contact with a stream of hot gases having a temperature of at least 100° C. in order to convert the sodium bicarbonate into sodium carbonate by calcination; the stream of hot gases comprising calcined particles subsequently being subjected to a separation stage in order to obtain, on the one hand, the reactive particles and, on the other hand, a separated stream of hot gases comprising CO₂ and steam, the separated stream of hot gases being at least partly recycled upstream of the separation stage.

The inventors have surprisingly observed that such a process enable to obtain high specific surface of reactive composition particles, even in presence in the stream of hot gases of high concentrations of carbon dioxide and/or water (as steam). In particular the water concentration (as steam) enables to speed up the calcination rate in particular for ‘flash’ calcination (reaction time of less than 15 min., or less than 5 min. or even less than 60 seconds) of particles based on sodium bicarbonate or sesquicarbonate and of median particle size of 35 μm or less.

Also the inventors have found surprisingly that the presence of compounds such as hydrocarbons, fatty hydrocarbons, fatty alcohols, fatty acids, or fatty acid salts, along with particles based on sodium bicarbonate and/or sodium sesquicarbonate increases sensitively the specific surface of the reactive composition and increases the capacity of the reactive composition particles to absorb detergent compounds.

The inventors have also observed surprisingly that the presence of ammonia (NH₃) in the stream of hot gases at low concentration of at least 0.5% up to 4 or 6% by weight, increases sensitively the specific surface developed during calcination of the reactive composition particles according the present invention.

Also another surprising beneficial effect of calcination with hot gas stream recycling, in particular for flash calcination, is that such process brings reactive compositions of higher absorption capacity of anionic detergent at a given specific surface than the known prior art.

### DETAILED DESCRIPTION OF THE INVENTION

Before the present formulations of the invention are described, it is to be understood that this invention is not limited to particular formulations described, since such formulations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise. By way of example, “an additive” means one additive or more than one additives.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Throughout this application, the term “about” is used to indicate that a value includes the standard deviation of error for the device or method being employed to determine the value.

As used herein, the term “average” refers to number average unless indicated otherwise.

As used herein, the terms “% by weight”, “wt %”, “weight percentage”, or “percentage by weight” are used interchangeably.

Unless otherwise indicated, a composition of a solid, or of a gas, expressed in percentage in present description corresponds to a percentage by weight.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different alternatives, embodiments and variants of the invention are defined in more detail. Each alternative and embodiment so defined may be combined with any other alternative and embodiment, and this for each variant unless clearly indicated to the contrary or clearly incompatible when the value range of a same parameter is disjoined. In particular, any feature indicated as being preferred or advantageous may be combined with any other feature or features indicated as being preferred or advantageous.

Furthermore, the particular features, structures or characteristics described in present description may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

In the process according to the invention, it is preferred to carry out a rapid calcination of particles based on sodium bicarbonate and/or sodium sesquicarbonate having a fine particle size, that is to say having a diameter D₅₀ of less than 35 μm. The term “particles based on sodium bicarbonate and/or sodium sesquicarbonate” is understood to mean particles comprising at least 60%, preferably 80%, more preferably at least 85% by weight, of sodium bicarbonate and/or sodium sesquicarbonate. The sodium sesquicarbonate is often trona. The particles based on sodium bicarbonate and/or sodium sesquicarbonate are advantageously based on sodium bicarbonate and advantageously comprise at least 60% by weight, preferably at least 80% by weight, more preferably at least 85%, even more preferably at least 90% by weight, most preferred at least 95% by weight of sodium bicarbonate.

According to the invention, these particles have to have a diameter D₅₀ (median particle size) of less than 35 μm. They often have a diameter D₅₀ of less than 30 μm, or preferably less than 25 μm or even more preferably less than 20 μm. In some cases, particle size distributions having a D₉₀ of less than 50 μm, preferably less than 35 μm, indeed even of less than 20 μm, are advantageous. Moreover, the D₅₀ can preferably be less than 15 μm, indeed even less than 10 μm.

In an alternative form of the composition according to the invention, the latter is provided in the form of particles having a distribution slope σ of less than 2.

The slope σ is defined by:

$$σ = \frac{{D}_{90} - {D}_{10}}{{D}_{50}}$$

D₉₀, respectively D₅₀ and D₁₀, with regard to them represent the diameter for which 90% (respectively 50% and 10%) of the particles of the reactive composition (expressed by weight) have a diameter of less than D₉₀ (respectively D₅₀ and D₁₀).

These as well as other particle size parameters in the context of this invention are measured by the laser ray diffraction analytical method. The assessment is conducted by laser diffraction and scattering on a Malvern Mastersizer S particle size analyser using an He—Ne laser source having a wavelength of 632.8 nm and a diameter of 18 mm, a measurement cell equipped with a backscatter 300 mm lens (300 RF), an MS 17 liquid preparation unit, and an automatic solvent filtration kit (“ethanol kit”) using ethanol saturated with bicarbonate.

In the context of this invention the BET (Brunauer, Emmett and Teller) specific surface is measured on a Micromeritics Gemini 2360 BET analyser using nitrogen as adsorbtive gas. The measure was realized on a powder sample presenting at least 1 m² of developed BET area, and was preliminary degassed with helium gas during 5 hours at ambient temperature (20 to 25° C.) in order to get rid of humidity traces adsorbed on the powder of sodium bicarbonate particles.

In one embodiment of the process according to the invention, the particles based on sodium bicarbonate comprise at least 80% by weight of sodium bicarbonate, less than 12% by weight of sodium carbonate and from 0.02 to 2% by weight of ammonia, expressed in the four of ammonium ions (NH₄⁺).

According to an alternative form of this embodiment, the particles based on sodium bicarbonate comprise ground crude bicarbonate particles from a soda plant. They are then advantageously obtained in the following way:
particles resulting from crude bicarbonate particles from an ammonia-soda plant are introduced into a gas stream comprising air in order to form a gas stream laden with particles;
the gas stream laden with particles is introduced into a mill in order to form a gas stream comprising ground particles having a diameter D₉₀ of less than 50 μm and a diameter D₅₀ of less than 35 μm preferably a diameter D₉₀ of less than 35 μm and a diameter D₅₀ of less than 20 μm, more preferably a diameter D₉₀ of less than 30 μm and a diameter D₅₀ of less than 15 μm, measured by laser diffractometry.

In the present process, the particles based on sodium bicarbonate are advantageously obtained by grinding particles comprising sodium bicarbonate having a particle size D₅₀ of at least 30 μm, preferably at least 45 μm, more preferably at least 60 μm and a particle size D₉₀ of at least 70 μm, preferably at least 85 μm, more preferably at least 100 μm.

In the alternative form of the invention, the particles of crude sodium bicarbonate from a soda plant (before grinding) advantageously have a particle size D₅₀ of at least 30 μm, preferably at least 45 μm, more preferably at least 60 μm and a particle size D₉₀ of at least 70 μm, preferably at least 85 μm, more preferably at least 100 μm.

In the present process of the invention, any type of mill can be used. In general, impact mills, in particular hammer mills, are highly suitable.

In this alternative form of the invention, the reactive composition is thus produced starting from crude bicarbonate particles from an ammonia-soda plant. This sodium bicarbonate is the product obtained by carbonation, with a gas comprising CO₂, of an ammoniacal brine. The particles formed at the end of the carbonation are separated from the slurry by filtration, in order to form the crude bicarbonate particles from an ammonia-soda plant. The ammoniacal brine is obtained by reaction of ammonia with a sodium chloride solution. The crude bicarbonate from an ammonia-soda plant comprises predominantly sodium bicarbonate but also sodium carbonate, ammonia, other compounds in small amounts and water. In the complete industrial process for the production of sodium bicarbonate, the crude sodium bicarbonate is successively calcined (in order to produce “light” sodium carbonate, this calcination moreover producing ammonia, water and CO₂), recrystallised and finally recarbonated with CO₂. This sequence of transformations exhibits a high cost, in particular a high energy cost (especially the calcination). The use of crude bicarbonate from a soda plant thus exhibits a marked economic advantage. It is sometimes advantageous for the crude bicarbonate particles from an ammonia-soda plant to be washed using a washing liquid before being introduced into the gas stream. In the process according to the invention, in order to obtain rapid calcination, it can prove to be advantageous for the stream of hot gases to have a temperature of at least 120° C., preferably of at least 130° C., more preferably of at least 150° C., or at least 170° C., indeed even of at least 200° C. Temperatures above 300° C. or above 250° C. are generally to be avoided. In some cases, the time elapsed between bringing into contact and the end of the separation stage is less than 30 minutes. This time is preferably less than 15 minutes, more preferably less than 10 minutes, even more preferably less than 5 minutes, most preferred less than 60 seconds. In practice, there exists a correspondence between this elapsed time and the temperature of the stream of hot gases, a high temperature making possible shorter calcination times.

The reactive composition particles obtained by the process according to the invention generally comprise at most 99% by weight of sodium carbonate. They often comprise less than 98% of it, or less than 95% of it, sometimes less than 90% of it. Values by weight of between 60% and 98%, or between 65% and 98%, generally between 70% and 95%, sometimes between 80% and 90%, are highly suitable.

The stream of hot gases in which the calcination takes place can have various compositions.

It is generally recommended for the stream of hot gases to comprise at least 40% by weight CO₂. Also it is preferred that the stream of hot gases to comprise at most 60% by weight water. It is also recommended for the stream of hot gases to comprise at least 0.5%, generally at least 1%, preferably at least 1.5% or even at least 2% by weight ammonia. Generally, the stream of hot gases comprises at most 10%, preferably at most 7%, more preferably at most 5% by weight ammonia.

In a first embodiment, it is recommended for this stream to comprise between 45% and 55% by weight CO₂. In a variant of this embodiment, the stream comprises between 40 and 50% water and between 1 and 4% ammonia.

In a second embodiment, it is recommended for this stream to comprise between 60%, preferably 65%, and 75% by weight CO₂. In a variant of this second embodiment, the stream comprises between 20 and 40% water, preferably between 25 and 35% by weight. Content in ammonia for this second embodiment is between 1%, preferably 2%, and 4% ammonia.

The stream of hot gases is often heated by passing through a heat exchanger, for example supplied with steam.

In an embodiment of the invention, the particles based on sodium bicarbonate and/or sodium sesquicarbonate brought into contact with the stream of hot gases comprise compounds or additives.

Recommended compounds are selected from: hydrocarbons, fatty alcohols, fatty acids, or fatty acid salts. Advantageously, the fatty acids are fatty acid molecules comprising 12 to 20 carbon atoms (C₁₂-C₂₀ fatty acid). More advantageously, the fatty acid is selected from lauric acid, myristic acid, palmitic acid, stearic acid, and mixtures thereof. Stearic acid is preferred. Fatty acid salts are advantageously selected from calcium, or magnesium acid salts or soaps of the fatty acids. More advantageously, the calcium or magnesium fatty acid salts are selected from calcium or magnesium salt of: lauric acid, myristic acid, palmitic acid, stearic acid, and mixtures thereof. Fatty acid salt is preferably selected from calcium stearate, magnesium stearate.

Recommended additives are selected from: zeolites, dolomite, magnesium hydroxide, magnesium (hydroxy) carbonate, lime, calcium phosphate, calcium carbonate, sodium chloride, zinc chloride, sodium sulphate, calcium fluoride, hydrocarbons, talc, lignite coke, activated carbon, and active charcoal.

Quantities of compound(s) and/or additive(s) are generally comprised between 0.1% by weight and 5% reported to the weight of particles based on sodium bicarbonate and/or sesquicarbonate. When the compound is a fatty acid salt or is calcium stearate, quantity of 0.25% to 1% by weight of compound is preferred. When the compound is a fatty acid, in particular stearic acid, quantity of 1 to 5% by weight is preferred.

Introduction of the compound and/or additives can for instance be performed by mixing them with the particles based on sodium bicarbonate before or during contact with the hot gas stream.

Below 210° C. and below 30 minutes of contact time of particles based on bicarbonate or sesquicarbonate with hot gas stream, organics molecules such as fatty acids or fatty acids salts, are stable enough to remain on the reactive composition particles.

Therefore the present invention relates also to reactive composition particles obtainable by the present invention, said reactive composition particle comprising: at least 60% by weight of sodium carbonate, and at most 40% by weight of sodium bicarbonate, and from 0.01 to 5% by weight of a compound selected from: hydrocarbons, fatty alcohols, fatty acids, or fatty acid salts, and said particles having a BET specific surface of at least 4 m²/g, and a median particle size D₅₀ of less than 35 μm, preferably of less than 30 μm, more preferably of less than 25 μm. Herein, the preferred fatty acids and fatty acid salts are defined as above.

And the present invention relates also to a composition comprising at least 90 weight % of the reactive composition particles according present invention and comprising from 0.01% to 10% by weight of additives selected from: zeolites, dolomite, magnesium hydroxide, magnesium (hydroxy) carbonate, lime, calcium carbonate, sodium chloride, zinc chloride, sodium sulphate, calcium fluoride, hydrocarbons, talc, lignite coke, activated carbon, and active charcoal. In the invention, the separated stream of hot gases, resulting from the stage of separation of the reactive composition particles, is at least partly recycled upstream of the separation stage, preferably upstream of the heat exchanger, when the process comprises one of them. This recycling has appeared to be highly advantageous for the CO₂, water, ammonia and energy managements. The part of separated hot gases which is recycled amounts preferably to at least 50% by weight, more preferably to at least 75%. It is recommended that the totality of the separated hot gases be recycled, except the quantity which is generated by the decomposition of the sodium bicarbonate into sodium carbonate. Preferably in the embodiments wherein the sodium bicarbonate comprises ground crude bicarbonate particles from an ammonia-soda plant, another part of the separated hot gases is advantageously purged and sent into an ammonia soda plant. This part amounts preferably to the quantity of separated hot gases which are generated by the decomposition of the sodium bicarbonate into sodium carbonate. Thermal energy of the purged stream is advantageously transferred by heat exchange to the stream of hot gases.

When the particles based on sodium bicarbonate are obtained by grinding particles comprising sodium bicarbonate having a particle size D₅₀ of at least 60 μm and a particle size D₉₀ of at least 100 μm, the separated stream of hot gases is advantageously recycled upstream of the mill.

In the invention, generally, the ammonia is defined as being gaseous ammonia, adsorbed and absorbed in the particles based on sodium bicarbonate, as measured, for example, by distillation at 30° C. In a first alternative form, it is nevertheless advantageous for the ammonia to be understood as also comprising ammonium carbonate and ammonium bicarbonate. In a second alternative form, the ammonia comprises any ammonia-comprising entity. In this case, the total nitrogen, expressed in the form of ammonium ions, is concerned. Both these alternative forms can be applied to all the embodiments described in this account, in which embodiments an ammonia content is specified.

The invention also relates to reactive composition particles which can be obtained by the process according to the invention, comprising at least 60% by weight, preferably at least 80% by weight and more preferably at least 90% by weight of sodium carbonate, having a BET specific surface of at least 4 m²/g, preferably of at least 6 m²/g, a median particle size D₅₀ of less than 35 μm, preferably of less than 30 μm, preferably of less than 25 μm, and even more preferably of less than 20 μm, and a median particle size D₉₀ of less than 50 μm, preferably of less than 40 μm, more preferably of less than 35 μm and even more preferably of less than 20 μm.

The invention also relates to reactive composition particles, comprising between 60% and 98% by weight, generally between 70% and 95% by weight and sometimes between 80% and 90% by weight of sodium carbonate, having a BET specific surface of at least 4 m²/g, preferably of at least 6 m²/g, a median particle size D₅₀ of less than 35 μm, preferably of less than 30 μm, more preferably of less than 25 μm and even more preferably of less than 20 μm, and a median particle size D₉₀ of less than 50 μm, preferably of less than 40 μm, more preferably of less than 35 μm and even more preferably of less than 20 μm. These particles can also advantageously be produced by the process according to the invention.

In particular the invention relates to reactive composition particles comprising: at least 60% by weight of sodium carbonate, and at most 40% by weight of sodium bicarbonate, and from 0.01 to 5% by weight of a compound selected from: hydrocarbons, fatty alcohols, fatty acids, or fatty acid salts, and said particles having a BET specific surface of at least 4 m²/g, and a median particle size D₅₀ of less than 35 μm, preferably of less than 30 μm, more preferably of less than 25 μm.

It is generally recommended that the reactive particles according to the invention be stored in a dry environment, such as dry air, advantageously having a humidity lower than a dew point of −40° C., for example in a silo, through which such a stream of dry air passes.

Finally, the invention also relates to a process for the purification of a flue gas comprising acidic impurities, for example hydrogen chloride or sulphur oxides, according to which a reactive composition which can be obtained by the process according to the invention, preferably obtained by the process according to the invention, is introduced into the flue gas, at a temperature of from 80, preferably from 90° C. to 600° C., and the flue gas is subsequently subjected to a filtration.

The reactive composition particles obtained according to the invention are particularly advantageous when the flue gas has a temperature of between 80, preferably 90° C. and 130° C.

### Example 1 (Conform)

The example which is described below, with reference to the appended FIGURE, illustrates a specific embodiment of the invention.

Particles (1) of crude bicarbonate from an ammonia-soda plant, having an ammonia content of the order of 1% by weight, expressed as NH₄⁺, and having a particle size distribution such that the diameter D₅₀ has a value of 80 μm and the diameter D₉₀ has a value of 150 μm, are washed with a centrifugal washer (A) using a washing liquid (2). A liquid (3), comprising ammonia, is extracted from the washer (A). At the outlet of the washer (A), the particles of crude bicarbonate from a soda plant (4) have an ammonia content of less than 1%, by weight, expressed as NH₄⁺, and a water content of 10%. The particles (4) are subsequently introduced into a dryer (B) operating at a temperature of 90° C. The particles (5), having a water content of less than 2%, are introduced into a stream of air (7) itself entering an impact mill (C). An amount by weight of 0.1% of calcium stearate and of 1% of calcium carbonate (6) is also introduced into the mill (C). The stream of air (8) comprising the ground particles of sodium bicarbonate, gaseous ammonia and water vapour, both released from the particles during the grinding, is finally introduced into a sleeve filter (D). The following are extracted therefrom; on the one hand, a stream of air (9) comprising water vapour and ammonia and, on the other hand, sodium bicarbonate particles (10) having the properties shown in Table 1.

TABLE 1

| | | | NH3 as | | | |
|---|---|---|---|---|---|---|
| D₉₀ | D₅₀ | H₂O | NH₄⁺ | NaHCO₃ | Na₂CO₃ | Additives |
| 20 μm | 10 μm | <1% | <0.1% | >85% | <11% | 1.1% |

The sodium bicarbonate particles (10) are then introduced into a stream of hot gases (12) having a temperature of 145° C., comprising, by weight, 47.5% of CO₂, 47.5% of steam and 5% of ammonia, in order to calcine them and to transform them essentially into sodium carbonate. After a residence time of approximately 15 minutes in this stream of hot gases, the calcined particles, constituting the reactive particles (14), are separated from the sleeve filter (F). The separated stream of hot gases (13) is then essentially returned to a heat exchanger (E), fed with steam (11), in order to regenerate the stream of hot gases (12). A part (17) of the separated stream is however sent to an ammonia soda plant. The reactive particles (14) are finally stored in a silo (G), through which passes a stream of dry air (15), having a humidity lower than a dew point of −40° C. The reactive particles have a specific surface of 9 m²/g.

### Example 2 (not Conform)

Known calcination of crude sodium bicarbonate (not conform to the invention) in a rotary dryer (without stream of hot gas and without recycling such hot gas) at 160-230° C. gives composition particles of sodium carbonate particles (light soda ash) of about 1.2 m²/g.

### Example 3 (Conform)

For the present example, particles of refined sodium bicarbonate (Bicar Z from Solvay Company comprising more than 99% sodium bicarbonate) and crude bicarbonate from an ammonia-soda plant (comprising 76% sodium bicarbonate, 8% sodium carbonate, 0.6% NH₄HCO₃, 1.7% NH₄Cl, 0.4% NaCl and 14% water) have been used to compare different operating conditions.

The above sample of crude bicarbonate from an ammonia soda plant was let to dry at 25° C. in a lab ventilated oven during one night up to obtain a dried crude sodium bicarbonate comprising about 3% water.

The samples of refined sodium bicarbonate and dried crude sodium bicarbonate were divided into several samples. To part of them compounds or additives were added to the refined sodium bicarbonate, or to dried crude bicarbonate particles to obtain particles based on sodium bicarbonate. The addition was done in a Lödige mixer.

The particles based on sodium bicarbonate were then grinded in an impact mill (Hozokawa Alpine UPZ 100 at 17 000 rev/min at a flow rate of 3 kg/h), to obtain grinded particles based on sodium bicarbonate with a D₅₀ of less than 35 μm.

The grinded particles were then introduced into a stream of hot gas of controlled composition (air or CO₂, and water as steam) heated with an heat exchanger at temperatures of 80 to 210° C., and introduced in a double cyclone reactor, with total residence time of about 15 to 30 seconds, to convert the sodium bicarbonate into sodium carbonate by calcination and to separate such obtained reactive composition comprising the compounds or additives when present, and a separated stream of hot gas comprising CO₂ and steam.

The obtained reactive composition is then stored in a dry container so that to prevent sensitive BET specific surface decrease and is chemically analysed to check that calcination rate of initial sodium bicarbonate is at least 85% (most of the samples having 85 to 95% or more than 95% calcination rate of the initial sodium bicarbonate).

The weight-average diameter (D₅₀) is measured by laser diffraction and scattering on a Malvern Mastersizer S particle size analyser using an He—Ne laser source having a wavelength of 632.8 nm and a diameter of 18 mm, a measurement cell equipped with a backscatter 300 mm lens (300 RF), an MS 17 liquid preparation unit, and an automatic solvent filtration kit (“ethanol kit”) using ethanol saturated with bicarbonate.

The BET (Brunauer, Emmett and Teller) specific surface was measured on a Micromeritics Gemini 2360 BET analyser using nitrogen as adsorptive gas. The measure was realized on a powder sample presenting at least 1 m² of developed BET area, and was preliminary degassed with helium gas during 5 hours at ambient temperature (20 to 25° C.) in order to get rid of humidity traces adsorbed on the powder of sodium bicarbonate particles.

In following tables when a composition of gas indicates “air” (or “CO₂”) and X % of steam or water (in gas state) and Y % in ammonia (NH₃), this corresponds to a composition of gas in weight consisting of (100%-X %-Y %) of “air” (or “CO₂”), and X % of steam (or water as gas) and Y % of NH3.

Tests results are given here after on tables 2 and 3 infra.

As one can see on table 2 the calcination rate of bicarbonate is improved when steam concentration is increased, when residence time is too short and the temperature to low to bring by a calcination rate of 85-95%, or >95%.

TABLE 2
Calcination rate of bicarbonate in reactive composition vs gas
stream composition and steam concentration

| | | Humidity of Gas stream (wt. %) | | | | | | | | |
|---|---|---|---|---|---|---|---|---|---|---|
| | | Steam 28.5% | | | Steam 48% | | | Steam 73% | | |
| | | T° C. of gas stream (° C.) | | | | | | | | |
| | | 150 | 180 | 210 | 150 | 180 | 210 | 150 | 180 | 210 |
| | Gas | Calcination rate of bicarbonate | | | | | | | | |
| Additive (%) | stream | in reactive composition (see legend infra) | | | | | | | | |
| Without - | Air | − | ++ | ++ | + | ++ | ++ | ++ | ++ | ++ |
| 0% | | | | | | | | | | |
| Without - | CO₂ | − | ++ | ++ | − | ++ | ++ | | ++ | ++ |
| 0% | | | | | | | | | | |
| Ca stearate - | CO₂ | − | ++ | ++ | − | ++ | ++ | | ++ | ++ |
| 0.5% | | | | | | | | | | |
| Stearic acid - | CO₂ | | | | − | − | + | − | + | + |
| 2% | | | | | | | | | | |

Legend on calcination rate of bicarbonate (molar %) is the following: −: <85%; +: 85-95%; ++: >95%

One can see on table 3 (infra next page) that calcium stearate and stearic acid sensitively increase the BET specific surface. Grinded calcium carbonate added to bicarbonate is detrimental to high specific surface.

One can see on table 4 (infra, on last page of description) that the presence of CO₂ along with steam (water vapour), replacing air and steam, has the effect to slightly decrease the obtained BET, and more sensitively when concentration of water (steam) of the hot gas stream increases (Specific surface (BET) of reactive composition obtained by calcining in a hot gas stream [Air, CO₂, and Steam] crude sodium bicarbonate).

The values indicated on table 4 are mean values on 5 sampling of reactive composition per operating conditions (standard deviation of 5 to 10% of the mean BET value).

Tests performed in same conditions with refined sodium bicarbonate (Bicar Z) give comparable results in BET specific surface with Air or CO₂ at 180° C. and 210° C. at 48% steam concentration compared to crude sodium bicarbonate from ammonia process.

TABLE 3
Specific surface (BET) of reactive composition obtained by
calcining in a hot gas stream crude sodium bicarbonate
Hot gas stream 210° C.:

| | BET surface | BET surface |
|---|---|---|
| Additive (wt. %) | (m²/g) | (m²/g) |
| | Air and steam | Air and steam |
| | (48 wt. % water) | (73 wt. % water) |
| 1. Without - 0% | 4.9 | 5.0 |
| 2. Ca stearate - 0.5% | 5.8 | 5.8 |
| 3. Ca stearate - 1% | 6.2 | 6.4 |
| 4. Stearic acid - 2% | 9.9 | 8.6 |
| 5. Stearic acid - 5% | — | 10.4 |
| 6. Grinded CaCO3 | — | 1.7 |
| (Omya violet) - 3% | | |
| 7. Ca3(PO4)2 - 3% | — | 5.2 |
| 8. Silica - 1% (Tixosyl 38 AB) | 8.3 | 5.3 |
| | CO₂ and steam | CO₂ and steam |
| | (48 wt. % water) | (73 wt. % water) |
| 9. Ca stearate - 0.5% | 6.0 | 5.2 |

### Example 4

Reactive composition particles prepared according example, are hand-mixed in a beaker and surfactant 4-dodecylbenzene sulfonic acid (CAS 121-65-3, 44198 Reference Sigma-Aldrich Chemie BV, Netherlands) is added drop by drop until the mixture starts to become sticky.

The amount of surfactant so absorbed is indicated on Table 5 infra.

TABLE 5
Amount of surfactant 4-dodecylbenzene sulfonic acid absorbable
on reactive composition particles

| | | | | Particle | BET | Absorbed |
|---|---|---|---|---|---|---|
| | | | | size | Specif. | Surfactant |
| Test | Na₂CO₃ | NaHCO₃ | Total | D₉₀ | surface | mL/g |
| Reference | g/kg | g/kg | g/kg | μm | m²/g | (% poids) |
| CBA-001 | 856 | 93 | 949 | <30 | 5.3 | 1.30 |
| | | | | | | (138%) |
| CBA-011 | 978 | 22 | 1000 | <30 | 7.7 | 1.80 |
| | | | | | | (191%) |
| CBA-013 | 985 | 15 | 1000 | <30 | 10.1 | 1.88 |
| | | | | | | (199%) |

The above figures show the excellent detergent absorption capacity of the reactive composition according the present invention.

By comparison, sodium bicarbonate of same particle size, calcined (not according the present invention) in a laboratory ventilated oven at 200° C. 2 hours on a metallic plate, and having a final BET specific of 7.9 m²/g have a significant lower absorption capacity, intermediate between values for light soda ash (40-50% absorption) and the above absorption figures of Table 5 (138-199%).

Should the disclosure of any patents, patent applications, and publications which are incorporated herein by reference conflict with the description of the present application to the extent that it may render a term unclear, the present description shall take precedence.

TABLE 4
Specific surface (BET) of reactive composition obtained by calcining in a hot gas stream
(Air, CO₂, and Steam concentration) crude sodium bicarbonate from Example 3.

| | | Humidity of hot gas stream (wt. %) | | | | | | |
|---|---|---|---|---|---|---|---|---|
| | | Steam | | Steam | | Steam | | |
| | | 28.5% | | 48% | | 73% | | |
| | | Temperature of Hot gas stream (° C.) | | | | | | |
| Test Ref. & Additive - wt. % | Hot gas stream | 180 | 210 | 180 | 210 | 150 | 180 | 210 |
| 10. Without - 0% | Air | 7.7 | 9.7 | 6.0 | 4.6 | 4.3 | 6.0 | 5.0 |
| 11. Ca stearate - 0.5% | Air | 9.2 | 9.7 | 8.1 | 5.8 | — | 7.9 | 5.8 |
| 12. Stearic acid - 2% | Air | 8.2 | 12.3 | 9.7 | 9.9 | 3.6 | 8.1 | 8.6 |
| 13. Without - 0% | CO₂ | — | — | 5.1 | 6.5 | 3.3 | 3.6 | 3.6 |
| 14. Ca stearate - 0.5% | CO₂ | 5.7 | 7.2 | 6.7 | 6.0 | | 5.4 | 5.2 |
| 15. Stearic acid - 2% | CO₂ | — | — | 9.4 | 8.6 | 5.2 | 8.5 | 7.6 |
| 16. Ca stearate - 0.5% | CO₂ + 1% NH₃ | 8.8 | — | 6.7 | — | — | — | — |
| 17. Without - 0% | CO₂ + 2% NH₃ | — | — | 6.5 | — | — | — | — |
| 18. Ca stearate - 0.5% | CO₂ + 2% NH₃ | 9.5 | 7.9 | 8.9 | 6.8 | — | 5.0 | — |
| 19. Ca stearate - 0.5% | CO₂ + 3% NH₃ | — | — | 5.9 | — | — | — | — |
| 20. Without - 0% | CO₂ + 4% NH₃ | — | — | 5.3 | 4.5 | — | — | — |
| 21. Ca stearate - 0.5% | CO₂ + 4% NH₃ | — | — | 7.4 | 6.0 | | 8.0 | 5.0 |
| 22. Without - 0% | CO₂ + 6% NH₃ | — | — | 4.4 | — | — | — | — |
| 23. Ca stearate - 0.5% | CO₂ + 6% NH₃ | — | — | 5.9 | — | — | — | — |

1. A process for producing reactive composition particles comprising at least 60% by weight of sodium carbonate and having a BET specific surface of at least 4 m²/g, according to which particles based on sodium bicarbonate and/or sodium sesquicarbonate having a median particle size D₅₀ of less than 35 μm, are brought into contact with a stream of hot gases having a temperature of greater than 100° C. in order to convert the sodium bicarbonate into sodium carbonate by calcination, the stream of hot gases comprising calcined particles subsequently being subjected to a separation stage in order to obtain the reactive composition particles and a separated stream of hot gases comprising CO₂ and steam, the separated stream of hot gases being at least partly recycled upstream of the separation stage.

2. The process according to claim 1, wherein the stream of hot gases comprises at least 0.5% by weight ammonia.

3. The process according to claim 1, wherein the stream of hot gases has a temperature of at least 130° C.

4. The process according to claim 1, wherein time elapsed between bringing into contact and the end of the separation stage is less than 30 minutes.

5. The process according to claim 1, wherein the particles based on sodium bicarbonate have a median particle size D₉₀ of less than 35 μm.

6. The process according to claim 1, wherein the stream of hot gases comprises at least 40% by weight of CO₂ and/or at most 60% by weight water.

7. The process according to claim 1, wherein part of the separated hot gases is purged and sent into an ammonia soda plant.

8. The process according to claim 1, wherein the particles based on sodium bicarbonate are obtained by grinding particles comprising sodium bicarbonate having a particle size D₅₀ of at least 30 μm and a particle size D₉₀ of at least 70 μm, wherein the grinding is carried out in an impact mill.

9. The process according to claim 1, wherein the particles based on sodium bicarbonate comprise ground crude bicarbonate particles from an ammonia-soda plant.

10. The process according to claim 8, wherein part of the separated stream of hot gases is recycled upstream of the mill.

11. The process according to claim 8, wherein a compound selected from the group consisting of: hydrocarbons, fatty hydrocarbons, fatty alcohols, fatty acids, and fatty acid salts, is added to the particles based on sodium bicarbonate and/or sodium sesquicarbonate before or during grinding.

12. The process according to claim 11 wherein the fatty acids or their salts are C₁₂-C₂₀ fatty acids or their salts or its salt, wherein the salts are preferably selected from calcium and magnesium salts.

13. The process according to claim 8, wherein an additive selected from the group consisting of: zeolites, dolomite, magnesium hydroxide, magnesium (hydroxy) carbonate, lime, calcium carbonate, sodium chloride, zinc chloride, sodium sulphate, calcium fluoride, hydrocarbons, talc, lignite coke, activated carbon, and active charcoal, is added to the particles based on sodium bicarbonate and/or sodium sesquicarbonate before or during grinding.

14. A process for purification of a flue gas comprising acidic impurities, according to which reactive composition particles which are obtained by the process according to claim 1 are introduced into the flue gas, at a temperature of 80 to 600° C., and the flue gas is subsequently subjected to a filtration.

15. Reactive composition particles comprising: at least 60% by weight of sodium carbonate, and at most 40% by weight of sodium bicarbonate, and from 0.01 to 5% by weight of a compound selected from the group consisting of: hydrocarbons, fatty alcohols, fatty acids, and fatty acid salts, and said particles having a BET specific surface of at least 4 m²/g, and a median particle size D₅₀ of less than 35 μm.

16. Reactive composition particles according to claim 15 comprising at least 80% by weight of sodium carbonate.

17. Reactive composition particles according to claim 15, comprising at most 20% by weight of sodium bicarbonate.

18. Reactive composition particles according to claim 15, comprising at most 2% by weight of water.

19. Reactive composition particles according to claim 15, having a diameter D₉₀ of less than 50 μm and a diameter D₅₀ of less than 35 μm measured by laser diffractometry.

20. A composition comprising at least 90 weight % of the reactive composition particles according to claim 15 and comprising from 0.01% to 10% by weight of an additive selected from the group consisting of: zeolites, dolomite, magnesium hydroxide, magnesium (hydroxy) carbonate, lime, calcium carbonate, sodium chloride, zinc chloride, sodium sulphate, calcium fluoride, hydrocarbons, talc, lignite coke, activated carbon, and active charcoal.
